(19) United States
(12) Patent Application Publication
(10) Pub. No.: US 2017/0155293 A1
(43) Pub. Date: Jun. 1, 2017

(54) POWER GENERATING APPARATUS

(71) Applicant: Izumi HAYASHI, Chiba (JP)

(72) Inventor: Izumi HAYASHI, Chiba (JP)

(21) Appl. No.: 15/012,005

(22) Filed: Feb. 1, 2016

(30) Foreign Application Priority Data
Nov. 30, 2015 (JP) 2015-233153

(51) Int. Cl. H02K 1/27

(52) U.S. Cl. CPC H02K 1/2746; Y10S 74/09; H02K 53/00

(57) ABSTRACT

Provided is a power generating apparatus configured to generate power efficiently. High attractive force is generated between an inner peripheral surface (21a) (positive polarity) of a first magnet body (11), and a first surface (45a) (negative polarity) of a second magnet body (45) inclined thereto. The attractive force causes the first surface (45a) to come close to the inner peripheral surface (21a), to thereby cause wheels (41) to travel on grooves (71) in a direction of arrows (A). With this, a rotator (31) is rotated by high rotational force in the direction of the arrows (A). Rotation of a rotary shaft (35) of the rotator (31) is converted to electricity by a converter.

### BACKGROUND

The present invention relates to a power generating apparatus configured to generate power efficiently.

There has been provided, for example, a system configured to generate electricity by using energy that is generated through combustion of fuels such as petroleum (refer to Japanese Patent Application Laid-open No. 2006-42571).

### SUMMARY

However, the above-mentioned related-art system discharges a large amount of carbon dioxide as a result of the combustion of the petroleum and the like, which causes various problems in the global environment.

In addition, the petroleum and the like are finite resources. In view of such circumstances, development of apparatus configured to generate power efficiently has been expected.

The present invention has been made in view of the circumstances as described above, and has an object to provide a power generating apparatus configured to generate power efficiently.

In order to achieve the above-mentioned object, according to a first aspect of the present invention, there is provided a power generating apparatus, including:

a first magnet body having an inner peripheral surface of a first polarity;

a rotator arranged on an inner side with respect to the first magnet body, and configured to rotate about a rotary shaft that is coaxial with a center of a circle along the inner peripheral surface of the first magnet body; and

a plurality of second magnet bodies arranged at radially outer ends of the rotator at intervals of a predetermined angle, each having a first surface of a second polarity that is reverse to the first polarity, and each inclined such that a predetermined acute angle is formed between the first surface and the inner peripheral surface of the first magnet body,

the rotator receiving rotational propulsive force that is generated by attractive force derived from magnetic force generated between the inner peripheral surface of the first magnet body and the first surface of each of the plurality of second magnet bodies.

The inventor of the present invention has found that the essence of forces to be generated by magnets resides not in repulsive force but in the attractive force. According to the present invention, the rotational propulsive force is generated by the attractive force derived from the magnetic force generated between the inner peripheral surface of the first magnet body and the first surface of each of the plurality of second magnet bodies.

Specifically, the first surface of each of the plurality of second magnet bodies and the inner peripheral surface of the first magnet body, which have the polarities reverse to each other, form the predetermined acute angle, to thereby generate the attractive force therebetween. As a result, the first surface side of each of the plurality of second magnet bodies should be tilted down toward the inner peripheral surface. However, the first magnet body and the plurality of second magnet bodies are each fixed, and hence do not come close to each other. Thus, a force generated at the time of the tilting is exerted as the rotational propulsive force.

It is preferred that, in the power generating apparatus according to the first aspect of the present invention,

the plurality of second magnet bodies each include a cuboid, and

the predetermined acute angle range approximately from 60 degrees to 75 degrees.

It is preferred that, in the power generating apparatus according to the first aspect of the present invention,

the rotator include a plurality of runners arranged at the radially outer ends, and

the plurality of runners each include
wheels configured to travel on grooves arranged on the inner peripheral surface of the first magnet body, and
a base configured to allow corresponding one of the plurality of second magnet bodies to be fixed to the base.

It is preferred that, in the power generating apparatus according to the first aspect of the present invention,

the rotator include a plurality of support portions that extend from the rotary shaft toward the inner peripheral surface of the first magnet body, and

the plurality of second magnet bodies be fixed respectively to distal ends of the plurality of support portions.

It is preferred that, in the power generating apparatus according to the first aspect of the present invention, the first magnet body include a plurality of magnet portions arranged at intervals of a predetermined angle along the inner peripheral surface and each having the same fan shape in cross-section.

It is preferred that, in the power generating apparatus according to the first aspect of the present invention,

a clearance be formed between adjacent two of the plurality of magnet portions along the inner peripheral surface, and,

when the wheels travel on the grooves, the plurality of second magnet bodies pass across the clearance.

It is preferred that, in the power generating apparatus according to the first aspect of the present invention, at least one of the plurality of magnet portions be movable in a direction away from an orbit of the plurality of second magnet bodies.

It is preferred that, in the power generating apparatus according to the first aspect of the present invention, the number of the plurality of second magnet bodies and the number of the plurality of magnet portions forming the first magnet body be equal to each other.

It is preferred that, in the power generating apparatus according to the first aspect of the present invention, the number of the plurality of second magnet bodies and the number of the plurality of magnet portions forming the first magnet body be different from each other.

It is preferred that the power generating apparatus according to the first aspect of the present invention further include a converter configured to convert rotation of the rotary shaft of the rotator to electricity.

According to a second aspect of the present invention, there is provided a power generating apparatus, including:

a first magnet body having an inner peripheral surface of a predetermined polarity;

a rotator arranged on an inner side with respect to the first magnet body, and configured to rotate about a rotary shaft that is coaxial with a center of a circle along the inner peripheral surface of the first magnet body; and

a plurality of second magnet bodies arranged at radially outer ends of the rotator at intervals of a predetermined angle, each having a first surface of the predetermined polarity, and each inclined such that a predetermined acute angle is formed between the first surface and the inner peripheral surface of the first magnet body.

It is preferred that, in the power generating apparatus according to the second aspect of the present invention, the first magnet body and the plurality of second magnet bodies each include a permanent magnet.

According to the present invention, it is possible to provide a power generating apparatus configured to generate power efficiently.

### BRIEF DESCRIPTION OF DRAWINGS

FIG. 1 is a front view of a power generating apparatus according to a first embodiment of the present invention;

FIG. 2 is a front view of a state in which a rotator of the power generating apparatus illustrated in FIG. 1 is rotated in a direction of arrows A from a rotational position illustrated in FIG. 1;

FIG. 3 is a sectional view of the rotator and a first magnet body, which is taken along a direction orthogonal to an advancing direction of second magnet bodies illustrated in FIG. 1;

FIG. 4 is an explanatory view of a state in which one of magnet portions under the states illustrated in FIG. 1 and FIG. 2 is moved to an outside such that rotation of the rotator is stopped;

FIG. 5 is a front view of a power generating apparatus according to a second embodiment of the present invention;

FIG. 6 is a front view of a power generating apparatus according to a third embodiment of the present invention;

FIG. 6 is a front view of a power generating apparatus according to a third embodiment of the present invention;

FIG. 7 is a front view of a modification of the power generating apparatus shown in FIG. 6; and

FIG. 8 is a front view of a power generating apparatus according to a fourth embodiment of the present invention.

### DETAILED DESCRIPTION OF EMBODIMENTS

In the following, description is made of power generating apparatus according to embodiments of the present invention.

### First Embodiment

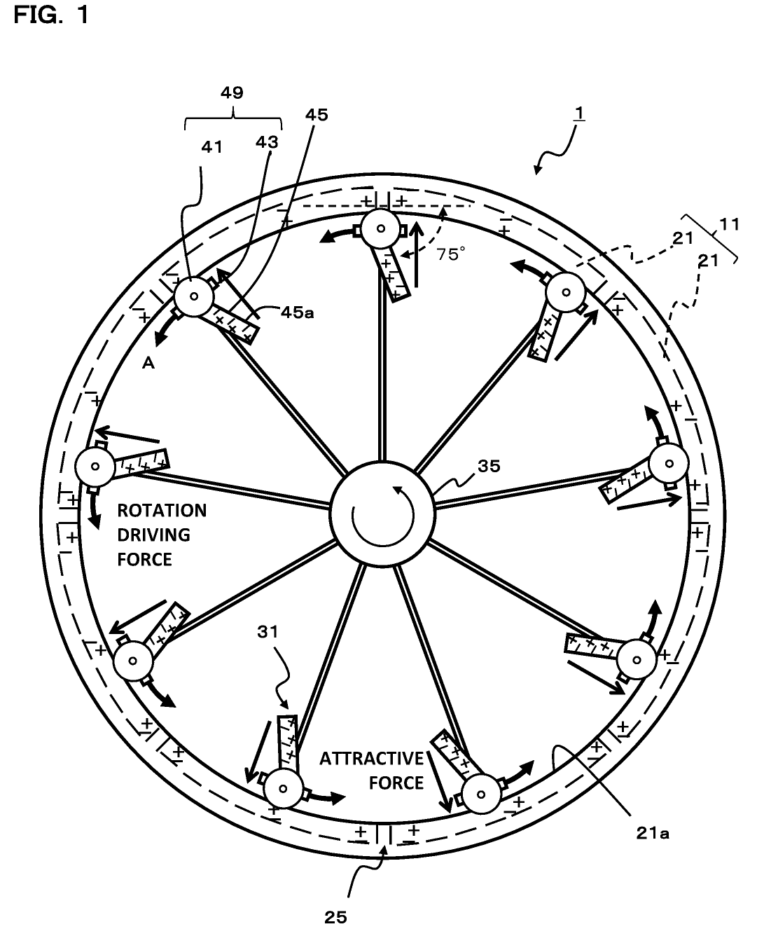

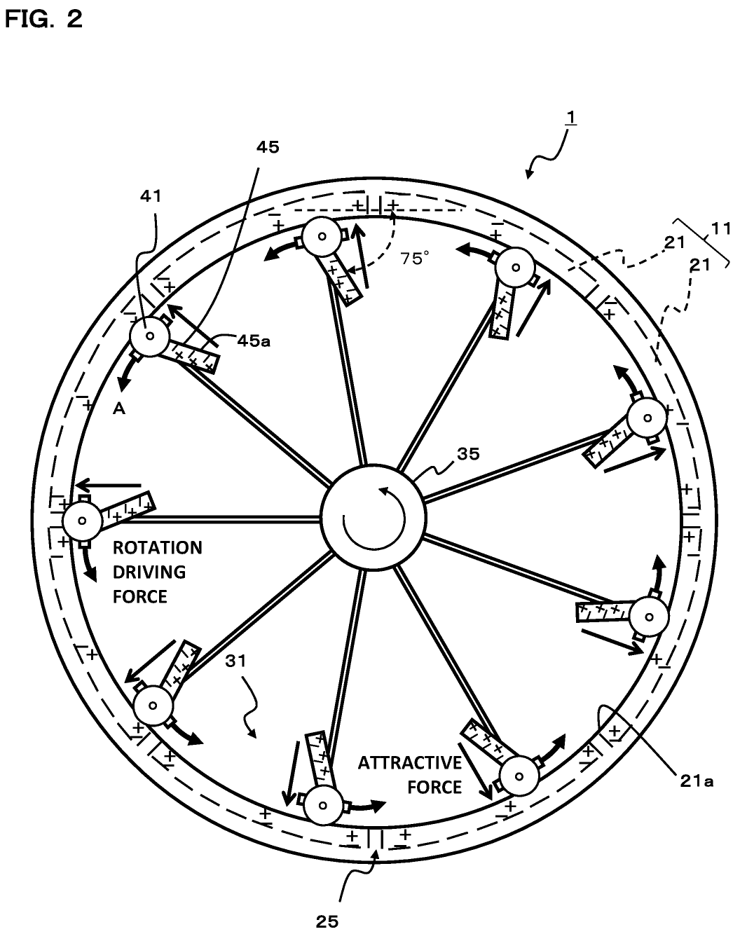

FIG. 1 is a front view of a power generating apparatus 1 according to a first embodiment of the present invention. FIG. 2 is a front view of a state in which a rotator 31 of the power generating apparatus 1 illustrated in FIG. 1 is rotated in a direction of arrows A from a rotational position illustrated in FIG. 1.

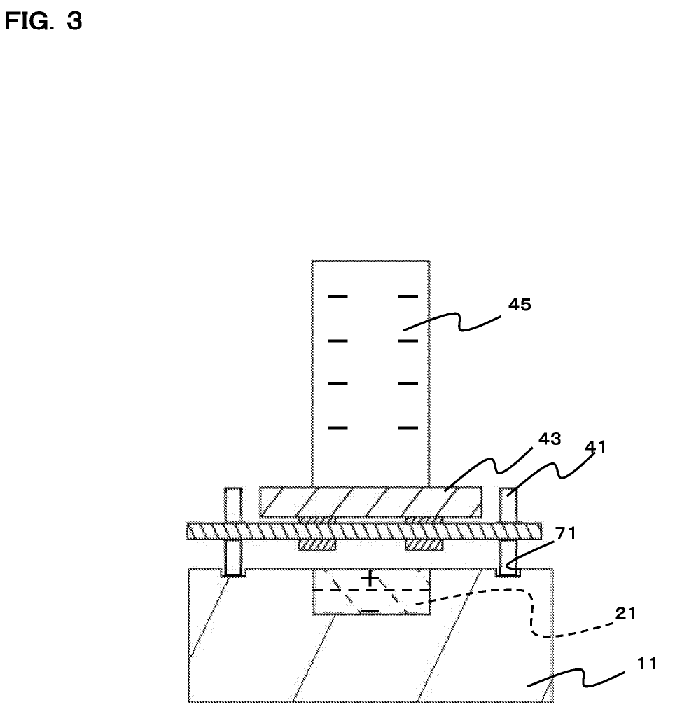

FIG. 3 is a sectional view of the rotator 31 and a first magnet body 11, which is taken along a direction orthogonal to an advancing direction of second magnet bodies 45 illustrated in FIG. 1.

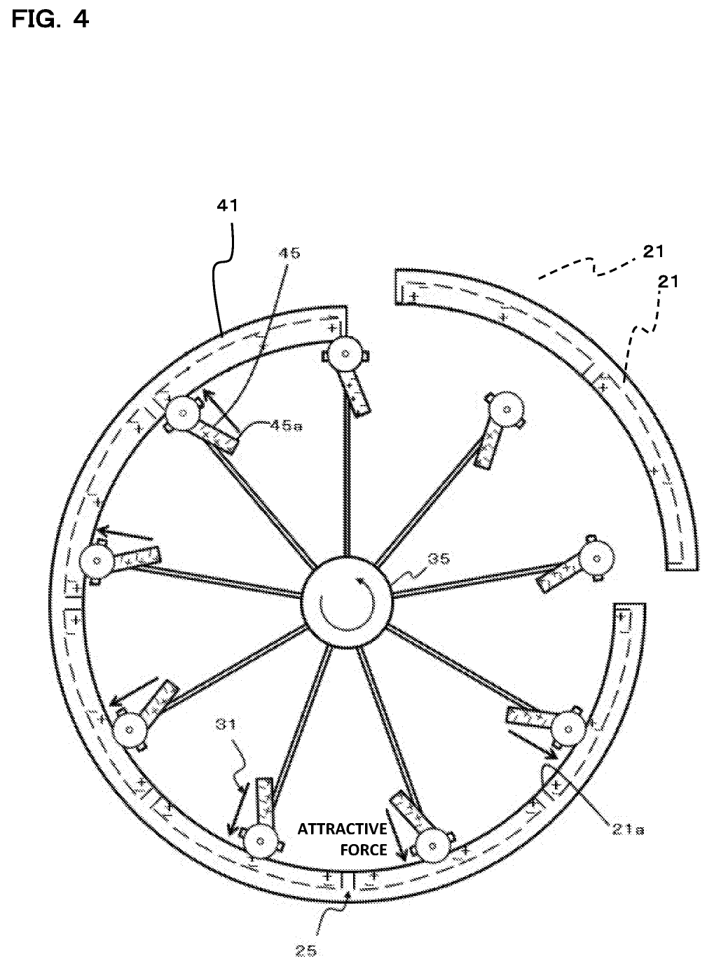

FIG. 4 is an explanatory view of a state in which one of magnet portions 21 under the states illustrated in FIG. 1 and FIG. 2 is moved to an outside such that rotation of the rotator 31 is stopped.

As illustrated in FIG. 1 and FIG. 2, the power generating apparatus 1 includes the first magnet body 11, the rotator 31, and the second magnet bodies 45.

The first magnet body 11 and the second magnet bodies 45 are each a permanent magnet.

The first magnet body 11 has an inner peripheral surface 21a of a first polarity (positive polarity N(+)).

The first magnet body 11 includes the plurality of magnet portions 21 arranged at intervals of a predetermined angle along the inner peripheral surface 21a and each having the same fan shape in cross-section. Two grooves 71 are arranged on the inner peripheral surface 21a over its circumferential direction.

As illustrated in FIG. 1 and FIG. 2, in the power generating apparatus 1, the first magnet body 11 includes the eight magnet portions 21. Clearances 25 in which magnets are not arranged are formed between adjacent ones of the magnet portions 21.

At least one of the eight magnet portions 21 is movable in a direction away from an orbit of the second magnet bodies 45. In this embodiment, as illustrated in FIG. 4, one of the magnet portions 21 can be moved to an outside manually or by a motor. When the magnet portion 21 is moved in this way, the rotation of the rotator 31 can be reduced or stopped.

The rotator 31 is arranged on an inner side with respect to the inner peripheral surface 21a of the cylindrical first magnet body 11, and includes the second magnet bodies 45 configured to rotate about a rotary shaft 35 that is coaxial with a center of a circle along the inner peripheral surface 21a of the first magnet body 11.

Rotation of the rotary shaft 35 is converted to electricity by a converter (not shown).

The rotator 31 includes nine runners 49 that are arranged at radially outer ends thereof. The runners 49 each include wheels 41 configured to travel on the grooves 71 arranged on the inner peripheral surface 21a of the first magnet body 11, and a base 43 configured to allow the second magnet body 45 to be fixed thereto.

The grooves 71 each have a height of, for example, 2 cm.

The rotator 31 includes nine support portions 37 that extend from the rotary shaft 35 toward the inner peripheral surface 21a of the first magnet body 11.

The base 43 is fixed to a distal end of each of the support portions 37, and the second magnet body 45 is fixed to the base 43.

The second magnet bodies 45 are arranged at the radially outer ends of the rotator 31 at intervals of a predetermined angle, and each have a first surface 45a of a second polarity (negative polarity S(−)) that is reverse to the first polarity. The second magnet bodies 45 are each inclined such that a predetermined acute angle is formed between the first surface 45a and the inner peripheral surface 21a of the first magnet body 11.

The second magnet bodies 45 each include a cuboid. Further, the predetermined angle ranges approximately from, for example, 60 degrees to 75 degrees.

Thus, the first surface 45a of the second magnet body 45 and the inner peripheral surface 21a of the first magnet body 11, which have the polarities reverse to each other, are attracted to each other by attractive force.

In the following, description is made of operation of the power generating apparatus 1 illustrated in FIG. 1 to FIG. 4.

[Rotation Operation]

For example, one of the magnet portions 21 at the position illustrated in FIG. 4 is moved to the position illustrated in FIG. 1. In other words, the magnet portion 21 is moved close to the orbit of the second magnet bodies 45.

With this, high attractive force is generated between the inner peripheral surface 21a (positive polarity) of the first magnet body 11, and the first surface 45a (negative polarity) of the second magnet body 45 inclined thereto.

This attractive force causes the first surface 45a to come close to the inner peripheral surface 21a. However, the first magnet body 11 and the second magnet body 45 are each fixed, and hence do not come close to each other. The attractive force generates high rotational force that causes the rotator 31 to rotate in the direction of the arrows A. With this, the wheels 41 travel on the grooves 71 in the direction of the arrows A. The rotation force is maintained, and the rotator 31 is forcefully rotated.

Note that, the power generating apparatus 1 includes the eight magnet portions 21 and the nine second magnet bodies 45, and hence all the nine second magnet bodies 45 do not simultaneously come to positions of facing the eight clearances 25 between the adjacent ones of the magnet portions 21. In other words, when one of the second magnet bodies 45 comes to the position of facing the clearance 25, the other eight second magnet bodies 45 are located at positions of facing the magnet portions 21. Thus, at any rotation angle, high rotational propulsive force can be generated in the direction of the arrows A.

Then, the rotation of the rotator 31 of the rotary shaft 35 is converted to electricity by the converter.

[Stop Operation]

As illustrated in FIG. 4, the two of the magnet portions 21 under the states illustrated in FIG. 1 and FIG. 2 is moved to the outside (direction away from the rotary shaft 35) manually or by the motor.

With this, when the second magnet body 45 reaches a position of the magnet portion 21 that has been moved to the outside, the rotational propulsive force in the direction of the arrows A cannot be generated. As a result, the rotator 31 is braked and stopped from rotating.

As described above, in the power generating apparatus 1, the high attractive force is generated between the inner peripheral surface 21a (positive polarity) of the first magnet body 11, and the first surface 45a (negative polarity) of each of the second magnet bodies 45 inclined thereto. This attractive force is exerted as the force of causing the wheels 41 to travel on the grooves 71 in the direction of the arrows A, that is, the rotational force.

Further, in the power generating apparatus 1, when the one of the magnet portions 21 is merely moved to the outside as illustrated in FIG. 4, the rotation of the rotator 31 can be stopped.

### Second Embodiment

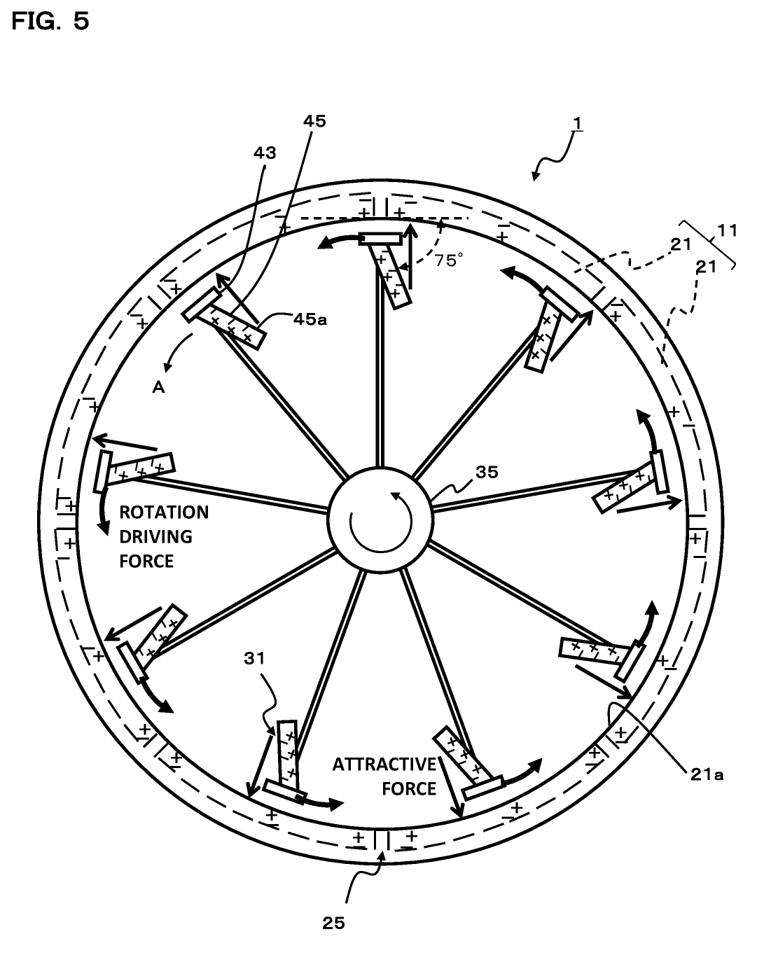

FIG. 5 is a front view of a power generating apparatus 201 according to a second embodiment of the present invention.

As illustrated in FIG. 5, in the power generating apparatus 201, as in the first embodiment, the first magnet body 11 includes the eight magnet portions 21.

In the power generating apparatus 201, the rotator 31 includes the nine second magnet bodies 45 fixed thereto, and is different from that in the first embodiment in that the wheels 41 are omitted.

Thus, clearances are formed between the bases 43 and the inner peripheral surface 21a of the first magnet body 11. However, as in the first embodiment, the attractive force is generated between the first surface 45a of each of the second magnet bodies 45 and the inner peripheral surface 21a, and hence the rotary shaft 35 is rotated in the direction of the arrows A.

Also in this embodiment, the same advantages as those in the first embodiment can be obtained. Further, in this embodiment, the wheels 41 are unnecessary, and hence a simple configuration can be obtained.

### Third Embodiment

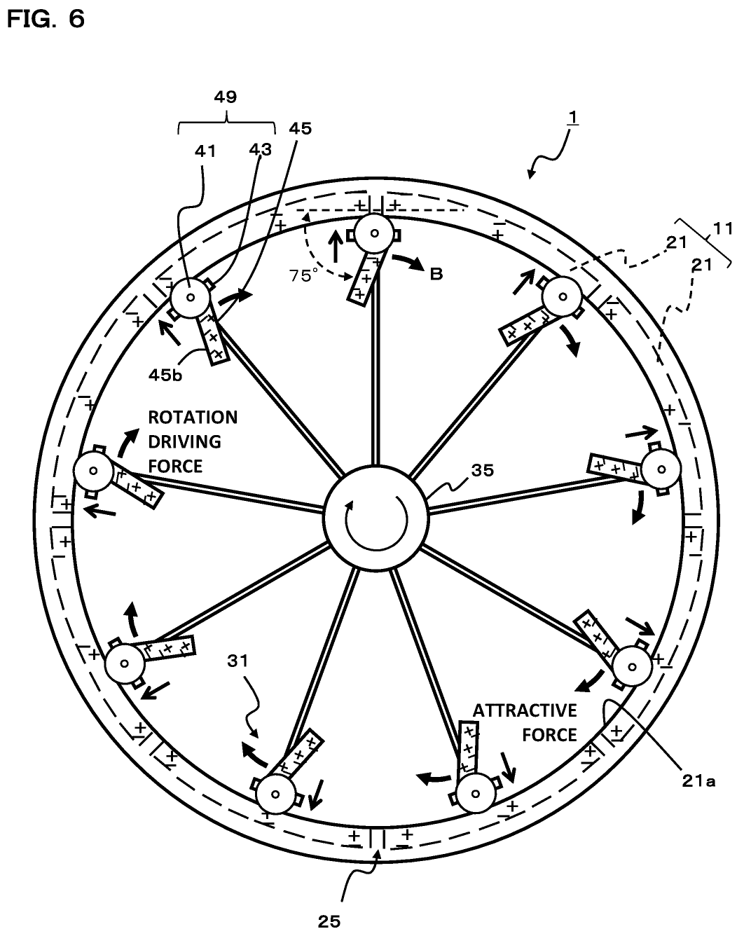

FIG. 6 is a front view of a power generating apparatus 301 according to a third embodiment of the present invention.

As illustrated in FIG. 6, in the power generating apparatus 301, as in the first embodiment, the first magnet body 11 includes the eight magnet portions 21. The clearances 25 in which the magnets are not arranged are formed between the adjacent ones of the magnet portions 21.

In the power generating apparatus 301, the rotator 31 includes nine second magnet bodies 45. The second magnet bodies 45 incline toward an opposite direction with the first embodiment. Therefore the attractive force causes the second surface 45b of the second magnet bodies 45 to come close to the inner peripheral surface 21a to cause the rotator to rotate in the direction of the arrows B which is opposite direction with the arrows A.

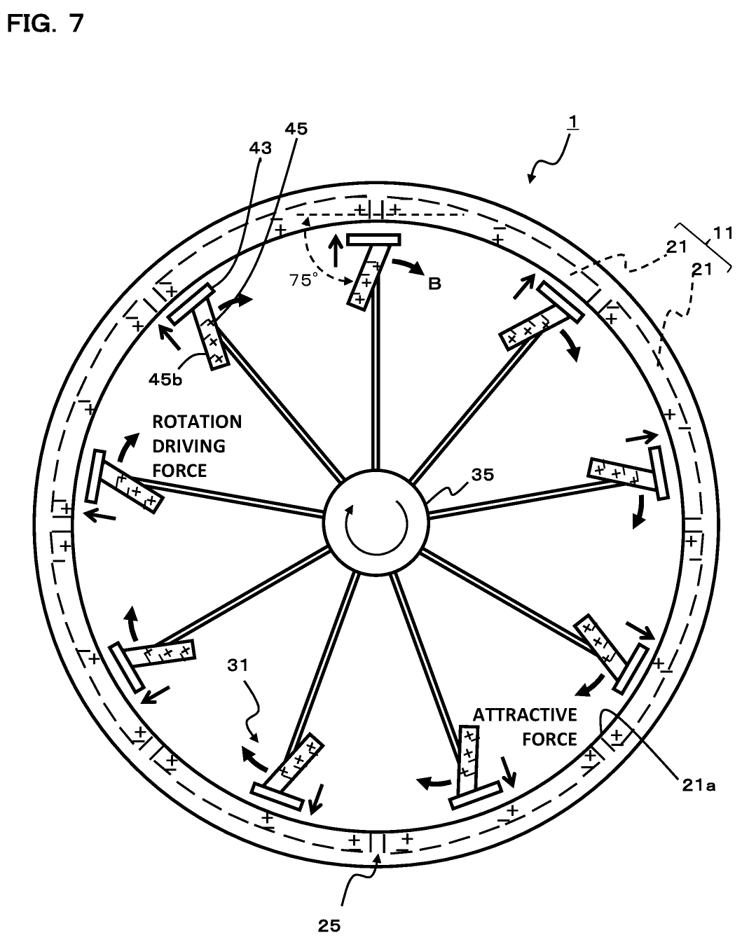

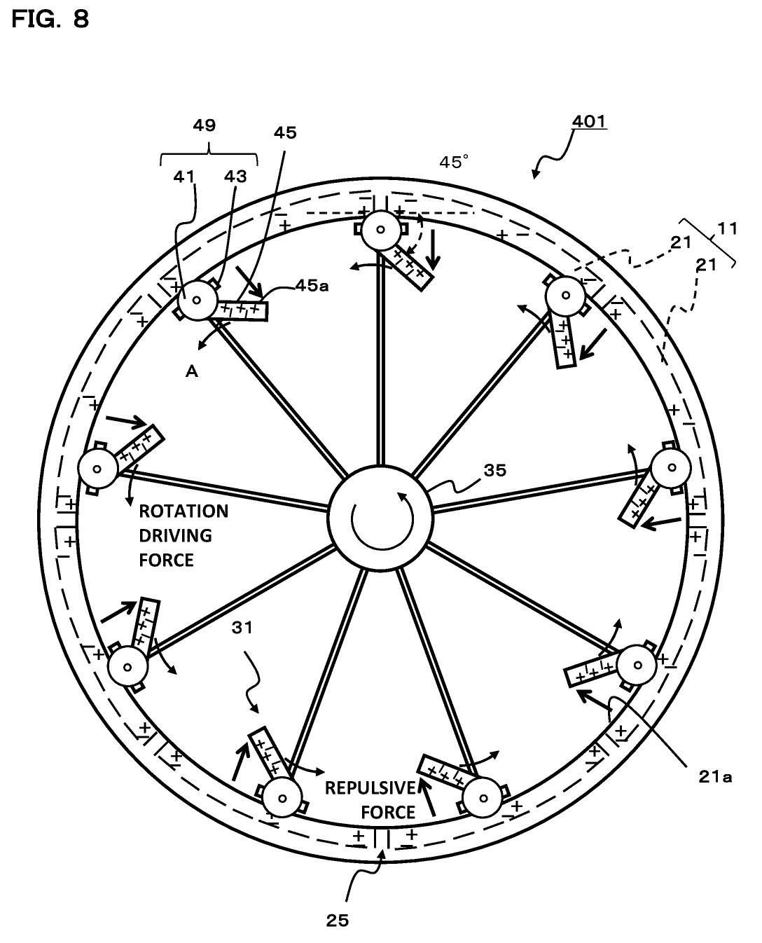

Note that, As shown in FIG. 7 it is possible to construct without the wheels 41 of the power generating apparatus shown in FIG. 6.

### Fourth Embodiment

FIG. 7 is a front view of a power generating apparatus 401 according to a fourth embodiment of the present invention.

As illustrated in FIG. 7, in the power generating apparatus 401, as in the first embodiment, the first magnet body 11 includes the eight magnet portions 21.

Further, the rotator 31 includes the nine second magnet bodies 45 that are arranged at the radially outer ends.

In this embodiment, the second magnet bodies 45 are arranged at the radially outer ends of the rotator 31 at intervals of a predetermined angle, and each have the first surface 45a of a second polarity (positive polarity N(+)) that is the same as the first polarity. The second magnet bodies 45 are each inclined such that an angle of, for example, 45 degrees is formed between the first surface 45a and the inner peripheral surface 21a of the first magnet body 11.

Also in this embodiment, the one of the magnet portions 21 is moved close to the orbit of the second magnet bodies 45.

With this, high repulsive force is generated between the inner peripheral surface 21a (positive polarity) of the first magnet body 11, and the first surface 45a (positive polarity) of the second magnet body 45 inclined thereto.

The repulsive force causes the first surface 45a to move away from the inner peripheral surface 21a, to thereby cause the wheels 41 to travel in the direction of the arrows A. With this, the rotator 31 is rotated by the high rotational force in the direction of arrows B which is an opposite direction of the arrows A.

The rotational force is maintained, and the rotator 31 is forcefully rotated.

Then, the rotation of the rotary shaft 35 of the rotator 31 is converted to electricity by the converter.

The present invention is not limited to the embodiments described above.

In other words, those skilled in the art may make various modifications, combinations, sub-combinations, and alterations of the components of the embodiments described above within the technical scope of the present invention or the equivalents thereof.

Specifically, the number of the magnet portions 21 and the number of the second magnet bodies 45 are not particularly limited, and may be arbitrarily set.

Further, in the case exemplified in the embodiments described above, as illustrated in FIG. 4, the two of the magnet portions 21 is moved to the outside such that the rotation of the rotator 31 is stopped. However, in order to stop the rotator 31, one or three or more of the magnet portions 21 may be moved to the outside.

Still further, with regard to the rotator 31, which is rotated counterclockwise in the case exemplified in the embodiments described above, the second magnet bodies 45 may be inclined to the opposite side with respect to the support portions 37 such that the rotator 31 is rotated clockwise.

The present invention is applicable to power generating apparatus capable of generating power efficiently.
1 power generating apparatus
11 first magnet body
21 magnet portion
21a inner peripheral surface
25 clearance
31 rotator
35 rotary shaft
37 support portion
41 wheel
43 base
45 second magnet body
45a first surface
45b second surface
71 groove

1. A power generating apparatus, comprising:
a first magnet body having an inner peripheral surface of a first polarity;
a rotator arranged on an inner side with respect to the first magnet body, and configured to rotate about a rotary shaft that is coaxial with a center of a circle along the inner peripheral surface of the first magnet body; and
a plurality of second magnet bodies arranged at radially outer ends of the rotator at intervals of a predetermined angle, each having a first surface of a second polarity that is reverse to the first polarity, and each inclined such that a predetermined acute angle is formed between the first surface and the inner peripheral surface of the first magnet body,
the rotator receiving rotational propulsive force that is generated by attractive force derived from magnetic force generated between the inner peripheral surface of the first magnet body and the first surface of each of the plurality of second magnet bodies.

2. The power generating apparatus according to claim 1,
wherein the plurality of second magnet bodies each include a cuboid, and
wherein the predetermined acute angle ranges approximately from 60 degrees to 75 degrees.

3. The power generating apparatus according to claim 1,
wherein the rotator includes a plurality of runners arranged at the radially outer ends, and
wherein the plurality of runners each include
wheels configured to travel on grooves arranged on the inner peripheral surface of the first magnet body, and
a base configured to allow corresponding one of the plurality of second magnet bodies to be fixed to the base.

4. The power generating apparatus according to claim 1,
wherein the rotator includes a plurality of support portions that extend from the rotary shaft toward the inner peripheral surface of the first magnet body, and
wherein the plurality of second magnet bodies are fixed respectively to distal ends of the plurality of support portions.

5. The power generating apparatus according to claim 1, wherein the first magnet body includes a plurality of magnet portions arranged at intervals of a predetermined angle along the inner peripheral surface and each having the same fan shape in cross-section.

6. The power generating apparatus according to claim 5,
wherein a clearance is formed between adjacent two of the plurality of magnet portions along the inner peripheral surface, and
wherein, when the wheels travel on the grooves, the plurality of second magnet bodies pass across the clearance.

7. The power generating apparatus according to claim 6, wherein at least one of the plurality of magnet portions is movable in a direction away from an orbit of the plurality of second magnet bodies.

8. The power generating apparatus according to claim 5, wherein the number of the plurality of second magnet bodies and the number of the plurality of magnet portions forming the first magnet body are equal to each other.

9. The power generating apparatus according to claim 5, wherein the number of the plurality of second magnet bodies and the number of the plurality of magnet portions forming the first magnet body are different from each other.

10. The power generating apparatus according to claim 1, further comprising a converter configured to convert rotation of the rotary shaft of the rotator to electricity.

11. A power generating apparatus, comprising:
a first magnet body having an inner peripheral surface of a predetermined polarity;
a rotator arranged on an inner side with respect to the first magnet body, and configured to rotate about a rotary shaft that is coaxial with a center of a circle along the inner peripheral surface of the first magnet body; and
a plurality of second magnet bodies arranged at radially outer ends of the rotator at intervals of a predetermined angle, each having a first surface of the predetermined polarity, and each inclined such that a predetermined acute angle is formed between the first surface and the inner peripheral surface of the first magnet body.

12. A power generating apparatus according to claim 1, wherein the first magnet body and the plurality of second magnet bodies each include a permanent magnet.

13. The power generating apparatus according to claim 2,
wherein the rotator includes a plurality of runners arranged at the radially outer ends, and
wherein the plurality of runners each include
wheels configured to travel on grooves arranged on the inner peripheral surface of the first magnet body, and
a base configured to allow corresponding one of the plurality of second magnet bodies to be fixed to the base.

14. The power generating apparatus according to claim 2,
wherein the rotator includes a plurality of support portions that extend from the rotary shaft toward the inner peripheral surface of the first magnet body, and
wherein the plurality of second magnet bodies are fixed respectively to distal ends of the plurality of support portions.

15. The power generating apparatus according to claim 3,
wherein the rotator includes a plurality of support portions that extend from the rotary shaft toward the inner peripheral surface of the first magnet body, and
wherein the plurality of second magnet bodies are fixed respectively to distal ends of the plurality of support portions.

16. The power generating apparatus according to claim 2, wherein the first magnet body includes a plurality of magnet portions arranged at intervals of a predetermined angle along the inner peripheral surface and each having the same fan shape in cross-section.

17. The power generating apparatus according to claim 3, wherein the first magnet body includes a plurality of magnet portions arranged at intervals of a predetermined angle along the inner peripheral surface and each having the same fan shape in cross-section.

18. The power generating apparatus according to claim 4, wherein the first magnet body includes a plurality of magnet portions arranged at intervals of a predetermined angle along the inner peripheral surface and each having the same fan shape in cross-section.

19. The power generating apparatus according to claim 2, further comprising a converter configured to convert rotation of the rotary shaft of the rotator to electricity.

20. The power generating apparatus according to claim 3, further comprising a converter configured to convert rotation of the rotary shaft of the rotator to electricity.
